(19) United States
(12) Patent Application Publication
(10) Pub. No.: US 2012/0273728 A1
(43) Pub. Date: Nov. 1, 2012

(54) STEAM REFORMING OF HYDROCARBONACEOUS FUELS OVER A NI-ALUMINA SPINEL CATALYST

(75) Inventors: Nicolas Abatzoglou, Sherbrooke (CA); Clémence Fauteux-Lefebvre, Sherbrooke (CA); Jasmin Blanchard, Sherbrooke (CA); François Gitzhofer, Sherbrooke (CA)

(73) Assignee: Universite de Sherbrooke, Sherbrooke, CA (US)

(21) Appl. No.: 13/391,578

(22) PCT Filed: Aug. 19, 2010
(86) PCT No.: PCT/CA10/01284

§ 371 Date: Jul. 2, 2012

Related U.S. Application Data
(60) Provisional application No. 61/235,835, filed on Aug. 21, 2009.

(51) Int. Cl. B01J 21/06; B01J 37/04; C10J 3/72; B01J 21/12

(52) U.S. Cl. 252/372; 502/335; 502/242

(57) ABSTRACT

A process for steam reforming of a hydrocarbonaceous fuel includes the steps of: providing a reactant mixture comprising H₂O and the hydrocarbonaceous fuel; and contacting the reactant mixture with a Al₂O₃-yttria-stabilized ZrO₂ (YSZ)-supported NiAl₂O₄ spinel catalyst under conditions wherein the reactant gas mixture is at least partially steam reformed into a product gas mixture including H₂ and CO. The synthesis gas (H₂ and CO) produced can be used as feed material for fuel cells. The catalyst includes a NiAl₂O₄ spinel-based catalytically active material; and a support material comprising: Al₂O₃ and ZrO₂. The Al₂O₃-YSZ-supported NiAl₂O₄ catalyst can be used in steam reforming of a liquid hydrocarbonaceous fuel.

### CROSS-REFERENCE TO RELATED APPLICATIONS

This application claims priority of U.S. provisional patent application No. 61/235,835 filed on Aug. 21, 2009, both the specification of which is hereby incorporated by reference.

### TECHNICAL FIELD OF THE INVENTION

The present invention relates to steam reforming of hydrocarbonaceous fuels and, more particularly, to steam reforming of hydrocarbonaceous fuels over a Ni-Alumina spinel catalyst. It also relates to new catalysts for steam reforming of hydrocarbonaceous fuels.

### BACKGROUND

Gaseous hydrogen (H₂) can be used as feed for Solid Oxide Fuel Cells (SOFC). Furthermore, it can be used altogether with carbon monoxide (CO) to produce synthesis gas, syngas, without harming the SOFC. Thus, the SOFC can use a mixture of H₂ and CO as co-fuel.

H₂ can be obtained from hydrocarbons reforming either by catalytic partial oxidation (see reaction 1 below), steam reforming (see reaction 2 below) or autothermal reforming.

CₙHₘ+n/2O₂→nCO+m/2H₂(ΔH<0) (1)

CₙHₘ+nH₂O→nCO+(n+m/2)H₂(ΔH>0) (2)

Steam reforming (reaction 2) is advantageous for producing higher H₂ concentration in the product mixture (or reaction products) compared to catalytic partial oxidation (reaction 1) since there is no H₂ associated with the oxidant in partial oxidation reactions (see Ibarreta and Sung (2006). Optimization of Jet-A fuel reforming for aerospace applications. Int. J. Hydrogen Energy, Vol. 31, n° 8, p. 1066-1078). In addition, partial oxidation is an exothermic reaction and hot spots at the catalytic bed are a usual technical nuisance, which leads to higher catalyst aging rates (Ibarreta and Sung, 2006).

Transition metals are commonly used as catalysts for reforming reactions. However, they typically deactivate during hydrocarbon reforming reactions due to (a) sintering, (b) sulphur poisoning or (c) coking. Sintering is mainly caused by the surface mobility of the active metals at high reaction temperatures. Sulphur poisoning is caused by organic sulphur contained in fossil fuels which, under the reforming conditions, is converted to S⁻² that reacts with the active metals at the catalyst surface. The so formed sulphides are catalytically inactive, because they prevent reactants from being adsorbed on the catalytic surface. Coking is the term used for carbon-rich compounds formation and deposition. There are two main undesirable reactions that cause carbon deposition: the Boudouard reaction (CO disproportionation to C and CO₂) and the hydrocarbons cracking. The deactivation through coking is different in non-noble and noble metals. Namely, metallic nickel allows for carbon diffusion and dissolution which leads to the formation of whisker carbon (Alvarez-Galvan, M. C., R. M. Navarro, F. Rosa, Y. Briceno, F. Gordillo Alvarez and J. L. G. Fierro (2008). Performance of La, Ce-modified alumina-supported Pt and Ni catalysts for the oxidative reforming of diesel hydrocarbons. Int. J. Hydrogen Energy, Vol. 33, n° 2, p. 652-663). On the opposite, noble metals do not dissolve significantly carbon; thus leading to less carbon formation and to different carbon deposition mechanisms (Alvarez-Galvan et al., 2008).

In diesel or other hydrocarbons reforming reactions, the catalyst is usually deactivated within 100 hours of use (Cheekatamarla, P. K. and A. M. Lane (2005). Catalytic autothermal reforming of diesel fuel for hydrogen generation in fuel cells: I. Activity tests and sulfur poisoning. J. Power Sources, Vol. 152, n° 1-2, p. 256-263; Rosa, F., E. Lopez, Y. Briceno, D. Sopena, R. M. Navarro, M. C. Alvarez-Galvan, J. L. G. Fierro and C. Bordons (2006). Design of a diesel reformer coupled to a PEMFC. Catal. Today, Vol. 116, n° 3, p. 324-333; Strohm, J. J., J. Zheng and C. Song (2006). Low-temperature steam reforming of jet fuel in the absence and presence of sulfur over Rh and Rh—Ni catalysts for fuel cells. J. Catal., Vol. 238, n° 2, p. 309-320). Depending upon the catalyst and reaction severity (mainly sufficiently low space velocities), concentrations close to the theoretical thermodynamic equilibrium can be reached. Strohm et al. (2006) studied the steam reforming of simulated jet fuel without sulphur and reported constant H₂ concentrations of 60% vol for 80 hours using a Ceria-Alumina-supported Rhodium (Rh) catalyst. The reactions took place at temperatures below 520° C. and a steam-to-carbon molar ratio (H₂O/C) of 3, i.e. there is a steam excess of 300%. When they added 35 ppm of sulphur in the feed, the catalyst was deactivated within 21 hours.

With an Al₂O₃-supported bimetallic noble metal with a metal loading <1.5% catalyst, Ming et al. (Steam reforming of hydrocarbon fuels. Catal. Today, Vol. 77, n° 1-2, p. 51-64, 2002) reported constant H₂ concentrations of 70% over a 73 hours steady state operation for hexadecane steam reforming. The H₂O/C molar ratio was 2.7 with an operating temperature of 800° C. When no-noble metals are used, there is deactivation within 8 hours with less H₂ in the products in most reaction severities (Alvarez-Galvan et al, 2008; Gardner, T. H., D. Shekhawat, D. A. Berry, M. W. Smith, M. Salazar and E. L. Kugler (2007). Effect of nickel hexaaluminate mirror cation on structure-sensitive reactions during n-tetradecane partial oxidation. Appl. Catal. A, Vol. 323, p. 1-8; Gould, B. D., A. R. Tadd and J. W. Schwank (2007). Nickel-catalyzed autothermal reforming of jet fuel surrogates: n-Dodecane, tetralin, and their mixture. J. Power Sources, Vol. 164, n° 1, p. 344-350). Kim et al. (Steam reforming of n-hexadecane over noble metal-modified Ni-based catalysts, Catal. Today, Vol. 136, p. 228-234, 2008)) obtained H₂ concentrations of 72% to 65% over a 53 hours of steady state operation with a Magnesia-Alumina-supported Nickel catalyst (Ni/MgO—Al₂O₃). This was obtained at temperature of 900° C., GHSV of 10 000 h⁻¹ and a H₂O/C molar ratio of 3. They also reported lower deactivation rates when noble metal (Rh) was added to the catalyst.

There is thus a need for a reforming process and a catalyst that lower the catalyst deactivation rate while maintaining high H₂ concentration in the product mixture and high conversion rates of the hydrocarbonaceous fuel.

### SUMMARY

It is therefore an aim of the present invention to address the above mentioned issues.

According to a general aspect, there is provided a process for steam reforming of a hydrocarbonaceous fuel, comprising the steps of: providing a reactant mixture comprising H₂O and the hydrocarbonaceous fuel; and contacting the reactant mixture with a Al₂O₃-yttria-stabilized ZrO₂ (YSZ)-supported NiAl₂O₄ spinel catalyst under conditions wherein the reactant gas mixture is at least partially steam reformed into a product gas mixture including H₂ and CO.

In an embodiment, the reactant mixture is in gaseous state when contacted with the Al₂O₃-YSZ-supported NiAl₂O₄ spinel catalyst.

In an embodiment, the hydrocarbonaceous fuel in liquid state at ambient temperature and atmospheric pressure.

The hydrocarbonaceous fuel can be selected from the group comprising: at least one hydrocarbon, at least one biofuel, at least one fossil fuel, at least one synthetic fuel and a mixture thereof. The hydrocarbonaceous fuel can be selected from the group consisting of: gasoline, diesel, biodiesel, commercial fossil-derived diesel, synthetic diesel, jet fuel, methanol, ethanol, bioethanol, methane, and mixture thereof.

In an embodiment, the reactant mixture comprises H₂O in a liquid state and the hydrocarbonaceous fuel in the liquid state; providing further comprises heating the reactant mixture to provide a gaseous reactant mixture; and contacting comprises contacting the gaseous reactant mixture with the Al₂O₃-YSZ-supported NiAl₂O₄ spinel catalyst.

In an embodiment, the process further comprises at least one of atomizing and vaporizing the H₂O and the hydrocarbonaceous fuel to form a fine droplet emulsion before contacting the Al₂O₃-YSZ-supported NiAl₂O₄ spinel catalyst. The process can further comprise adding a surfactant to the H₂O and the hydrocarbonaceous fuel before atomizing or vaporizing the H₂O and the hydrocarbonaceous fuel to form the emulsion.

In an embodiment, the contacting is carried out at a temperature between 500° C. and 900° C.

In an embodiment, the hydrocarbonaceous fuel comprises carbon and the reactant mixture has a H₂O:carbon ratio between 2.3 and 3.

In an embodiment, the contacting is carried out with a gas hourly space velocity ranging between 300 cm³g⁻¹h⁻¹ and 200 000 cm³g⁻¹h⁻¹.

In an embodiment, the Al₂O₃-YSZ-supported NiAl₂O₄ spinel catalyst is substantially free of metallic nickel and nickel oxide.

In an embodiment, the Al₂O₃-YSZ-supported NiAl₂O₄ spinel catalyst has a ratio Al₂O₃/YSZ ranging between 1/5 and 5/1.

In an embodiment, the Al₂O₃-YSZ support consists essentially of Al₂O₃ and YSZ and comprises between 1 w/w % to 2 w/w % of yttria. In an embodiment, the catalyst comprises an active phase consisting essentially of the NiAl₂O₄ spinel.

In an embodiment, the Al₂O₃-YSZ-supported NiAl₂O₄ spinel catalyst has a molar ratio of Ni/Al₂O₃ smaller or equal to 1.

In an embodiment, the Al₂O₃-YSZ-supported NiAl₂O₄ spinel catalyst comprises between 1 and 10 w/w % of nickel.

In an embodiment, the Al₂O₃-YSZ-supported NiAl₂O₄ spinel catalyst is dispersed in quartz wool.

According to a general aspect, there is provided a synthesis gas for fuel cells obtained by the process described above.

According to another general aspect, there is provided a process for the production of H₂ comprising the steps of: submitting a reactant mixture including a hydrocarbonaceous fuel and H₂O under steam reforming conditions; and contacting the reactant mixture under steam reforming conditions with a Al₂O₃-YSZ-supported Ni—Al₂O₄ spinel catalyst.

In an embodiment, the reactant mixture is in gaseous state when contacted with the Al₂O₃-YSZ-supported NiAl₂O₄ spinel catalyst and the hydrocarbonaceous fuel in liquid state at ambient temperature and atmospheric pressure.

The hydrocarbonaceous fuel can be selected from the group comprising: at least one hydrocarbon, at least one biofuel, at least one fossil fuel, at least one synthetic fuel and a mixture thereof.

In an embodiment, the reactant mixture comprises H₂O in a liquid state and the hydrocarbonaceous fuel in the liquid state; the process further comprises heating the reactant mixture to provide a gaseous reactant mixture; and contacting comprises contacting the gaseous reactant mixture with the Al₂O₃-YSZ-supported NiAl₂O₄ spinel catalyst.

In an embodiment, the submitting comprises at least one of atomizing and vaporizing the H₂O and the hydrocarbonaceous fuel to form an emulsion before contacting the Al₂O₃-YSZ-supported NiAl₂O₄ spinel catalyst.

In an embodiment, the process can further comprise adding a surfactant to the H₂O and the hydrocarbonaceous fuel before atomizing or vaporizing the H₂O and the hydrocarbonaceous fuel to form the emulsion.

In an embodiment, the contacting is carried out at a temperature between 500° C. and 900° C., with a H₂O:carbon ratio between 2.3 and 3, and a gas hourly space velocity ranging between 300 cm³g⁻¹h⁻¹ and 200 000 cm³g⁻¹h⁻¹.

In an embodiment, the Al₂O₃-YSZ-supported NiAl₂O₄ spinel catalyst is substantially free of metallic nickel and nickel oxide, comprises between 1 w/w % to 2 w/w % of yttria, and has a ratio Al₂O₃/YSZ ranging between 1/5 and 5/1.

In an embodiment, the Al₂O₃-YSZ support consists essentially of Al₂O₃ and YSZ, the catalyst comprises an active phase consisting essentially of the NiAl₂O₄ spinel, and the molar ratio of Ni/Al₂O₃ in the entire (total) catalyst is smaller than 1.

According to a further general aspect, there is provided a catalyst for steam reforming of a hydrocarbonaceous fuel, the catalyst comprising: a NiAl₂O₄ spinel-based catalytically active material; and a support material comprising: Al₂O₃ and ZrO₂.

In an embodiment, the ZrO₂ of the support material comprises yttria-stabilized zirconia (YSZ) and the catalyst comprises a Al₂O₃-YSZ-supported NiAl₂O₄.

In an embodiment, Y₂O₃ is present in YSZ at about 1 w/w % to 2 w/w %.

In an embodiment, the catalyst is substantially free of metallic nickel and nickel oxide.

In an embodiment, the catalyst has a ratio Al₂O₃/YSZ ranging between 1/5 and 5/1.

In an embodiment, the support material consists essentially of Al₂O₃ and YSZ and the catalytically active material consists essentially of the NiAl₂O₄ spinel.

In an embodiment, the molar ratio of Ni/Al₂O₃ is smaller or equal to 1.

In an embodiment, the catalyst comprises between 1 and 10 w/w % of nickel.

The Al₂O₃-YSZ-supported NiAl₂O₄ catalyst described above can be used in steam reforming of a liquid hydrocarbonaceous fuel.

According to a general aspect, there is provided a method for the preparation of a Al₂O₃-YSZ-supported NiAl₂O₄ spinel catalyst, comprising the steps of: mechanical mixing Al₂O₃ and yttria-stabilized zirconia (YSZ) powders to form a mixed powder; wet impregnation of the mixed powder with an acquous nitrate solution to form an impregnated powder; and submitting the impregnated powder under conditions to allow decomposition of nitrate and formation of NiAl₂O₄.

In an embodiment, the Al₂O₃ and YSZ powders are mixed in a ratio of 1/1.

In an embodiment, the acquous nitrate solution comprises Ni(NO₃)₂.6H₂O.

In an embodiment, the Al₂O₃ and YSZ powders comprise particulate materials smaller than about 40 μm.

In an embodiment, submitting is carried out at a temperature ranging between 850° C. and 1200° C. for 1 to 8 hours. In an embodiment, the submitting is carried under conditions to obtain the Al₂O₃-YSZ-supported NiAl₂O₄ spinel catalyst substantially free of metallic nickel and nickel oxide.

In an embodiment, Y₂O₃ is present in YSZ at about 1 w/w % to 2 w/w %.

In an embodiment, the Al₂O₃-YSZ-supported NiAl₂O₄ spinel catalyst has a ratio Al₂O₃/YSZ ranging between 1/5 and 5/1.

In an embodiment, the molar ratio of Ni/Al₂O₃ is smaller or equal to 1.

In an embodiment, the Al₂O₃-YSZ-supported NiAl₂O₄ spinel catalyst comprises between 1 and 10 w/w % of nickel.

In this specification, the term “hydrocarbonaceous fuel” is intended to mean compounds comprising carbon and hydrogen including hydrocarbons (e.g. methane, propane, hexane, benzene, hexadecane, tetralin, etc.), oxygen-containing fuels (i.e. alcohols such as methanol, ethanol, propanol, butanol, etc.) and fuels (e.g. fossil fuels, biofuels, diesel, biodiesel, etc.). The hydrocarbonaceous fuel can either be solid, liquid or gaseous at room temperature and atmospheric pressure.

In this specification, the term “hydrocarbon” is intended to mean organic compounds, such as methane, propane, hexane, benzene, hexadecane, tetralin, that contain only carbon and hydrogen.

### BRIEF DESCRIPTION OF THE DRAWINGS

Further features and advantages of the present invention will become apparent from the following detailed description, taken in combination with the appended drawings, in which:

FIG. 1 is scanning electron microscopic (SEM) pictures of the NiAl₂O₄/Al₂O₃-YSZ catalyst before steam reforming;

FIG. 2 is SEM-EDXS graphs and pictures of the NiAl₂O₄/Al₂O₃-YSZ catalyst before steam reforming;

FIG. 3 is graphs showing the chemical analysis of the NiAl₂O₄/Al₂O₃-YSZ catalyst before reforming with FIG. 3(a) showing the nickel XPS analysis with the positions at which NiO and NiAl2O4 are measured and FIG. 3(b) showing an XRD analysis;

FIG. 4 is a schematic view of a reactor for steam reforming of hydrocarbonaceous gases;

FIG. 5 is a graph showing the gaseous concentrations of the product mixture over time for propane steam reforming using a NiAl₂O₄/Al₂O₃-YSZ-1 catalyst;

FIG. 6 is a SEM picture of the NiAl₂O₄/Al₂O₃-YSZ-1 catalyst before propane steam reforming;

FIG. 7 is a SEM picture of the NiAl₂O₄/Al₂O₃-YSZ-1 catalyst after 12 hours of propane steam reforming;

FIG. 8 is a graph showing the gaseous concentrations of the product mixture over time for hexadecane steam reforming without catalyst;

FIG. 9 is a graph showing the gaseous concentrations of the product mixture over time for hexadecane steam reforming with the NiAl₂O₄/Al₂O₃-YSZ-1 catalyst at different temperatures and GHSV and a H₂O/C molar ratio of 2.5;

FIG. 10 is a SEM picture of the NiAl₂O₄/Al₂O₃-YSZ-1 catalyst after 22 hours of hexadecane steam reforming;

FIG. 11 is a graph showing the yield of the product mixture components over time for hexadecane steam reforming with a NiAl₂O₄/Al₂O₃-YSZ-2 catalyst at a reaction temperature of 710° C., GHSV of 5 000 cm³g⁻¹h⁻¹, and a H₂O/C molar ratio of 2.5 (experiment A);

FIG. 12 is a graph showing the yield of the product mixture components over time for hexadecane steam reforming with the NiAl₂O₄/Al₂O₃-YSZ-2 catalyst at a reaction temperature of 670° C., GHSV of 4 800 cm³g⁻¹h⁻¹, and a H₂O/C molar ratio of 2.5 (experiment B);

FIG. 13 is a graph showing the yield of the product mixture components over time for hexadecane steam reforming with the NiAl₂O₄/Al₂O₃-YSZ-2 catalyst at a reaction temperature of 670° C., GHSV of 12 800 cm³g⁻¹h⁻¹, and a H₂O/C molar ratio of 2.5 (experiment C);

FIG. 14 is a SEM picture of the NiAl₂O₄/Al₂O₃-YSZ-2 catalyst after hexadecane steam reforming for experiment A;

FIG. 15 is a SEM picture of the NiAl₂O₄/Al₂O₃-YSZ-2 catalyst after hexadecane steam reforming for experiment C;

FIG. 16 is SEM-EDXS graphs and pictures of the NiAl₂O₄/Al₂O₃-YSZ-2 catalyst after hexadecane steam reforming for experiment A;

FIG. 17 is SEM-EDXS graphs and pictures of the NiAl₂O₄/Al₂O₃-YSZ-2 catalyst after hexadecane steam reforming for experiment B;

FIG. 18 is SEM-EDXS graphs and pictures of the NiAl₂O₄/Al₂O₃-YSZ-2 catalyst after hexadecane steam reforming for experiment C;

FIG. 19 is SEM-EDXS graphs and pictures of a Ni/Al₂O₃-YSZ-2 catalyst after hexadecane steam reforming;

FIG. 20 is a graph showing the yield of the product mixture components over time for tetralin steam reforming with the NiAl₂O₄/Al₂O₃-YSZ-2 catalyst at a reaction temperature of 705° C., GHSV of 4 800 cm³g⁻¹h⁻¹, and a H₂O/C molar ratio of 2.3;

FIG. 21 is SEM-EDXS graphs and pictures of a NiAl₂O₄/Al₂O₃-YSZ-2 catalyst after tetralin steam reforming;

FIG. 22 is a graph showing the equilibrium concentrations of the gaseous product mixture as a function of the reaction temperature for hexadecane steam reforming with a H₂O/C molar ratio of 2.5;

FIG. 23 is a graph showing the comparison of equilibrium and experimental concentrations for hexadecane steam reforming with the NiAl₂O₄/Al₂O₃-YSZ-2 catalyst;

FIG. 24 is a graph showing the comparison of equilibrium and experimental concentrations for tetralin steam reforming with the NiAl₂O₄/Al₂O₃-YSZ-2 catalyst;

FIG. 25 is graphs showing the experimental versus theoretical concentrations in a biodiesel reforming product mixture; and

FIG. 26 is a SEM picture of the NiAl₂O₄/Al₂O₃-YSZ catalyst after run B for biodiesel reforming.

It will be noted that throughout the appended drawings, like features are identified by like reference numerals.

### DETAILED DESCRIPTION

Catalysts have been developed for steam reforming of hydrocarbonaceous fuels. The catalysts are nickel-based and alumina/yttria (Y₂O₃)-stabilized zirconia (ZrO₂) (YSZ) supported and, more particularly, they are Ni-alumina spinel catalysts and Al₂O₃/YSZ supported (or Al₂O₃/YSZ-supported NiAl₂O₄ spinel catalysts). Reforming converts a reactant mixture including hydrocarbonaceous fuels, such as propane, hexadecane, diesel, and biodiesel, oxygen-containing fuels, into a product mixture, mainly composed of H₂ and CO, i.e. synthesis gas. The reactant mixture in gaseous state contacts the catalyst under conditions for steam reforming of the hydrocarbonaceous fuel for generating a gaseous product mixture including CO and H₂.

The Ni-alumina spinel catalyst is substantially free of metallic Ni and nickel oxide to reduce its tendency for carbon formation and deposition during the steam reforming process. In an embodiment, the nickel spinel is substantially pure and supported on the Al₂O₃-YSZ substrate. As it will be shown below, it has been found that Ni-spinels are stable and have a high resistance to coke formation.

The ceramic support Al₂O₃-YSZ includes a mixture of Al₂O₃ and zirconia (ZrO₂). In an embodiment, the zirconia is stabilized by yttria. For instance, the zirconia can be stabilized by the addition of 1 w/w % to 2 w/w % of yttria. The ratio Al₂O₃/YSZ can range between 1/5 and 5/1. In an embodiment, the ratio Al₂O₃/YSZ ranges between 1/2 and 2/1 and, in a particular embodiment, the ratio Al₂O₃/YSZ is about 1/1.

The ceramic support Al₂O₃-YSZ can be obtained by mechanically mixing together Al₂O₃ and YSZ powders, as it will be described below in more details. The particle size can range between 50 nm and 40 μm, preferentially between 1 and 40 μm.

The ceramic support Al₂O₃-YSZ can include other elements such as and without being limitative MgO, MgAl₂O₄, Cr₂O₃, La₂O₃, SiO₂, CaO, K₂O, and TiO₂. For instance and without being limitative, the ceramic support could be Al₂O₃-YSZ doped with MgO.

The catalytically active phase includes a nickel spinet. Spinets are any of a class of minerals of general formulation A²⁺B₂³⁺O₄²⁻. The catalyst spinel is of the form NiAl₂O₄.

In an embodiment, the nickel represents about between 1 and 10 w/w % of the final catalyst formulation (including the ceramic support). In a particular embodiment, the nickel represents about 5 w/w % of the final, dry catalyst formulation. The ratio Ni/Al₂O₃ of the entire (total catalyst) should be equal or inferior to 1 to avoid metallic Ni and nickel oxide in the catalyst, as it will be described in more details below. The ratio Ni/Al₂O₃ of the spinet should be equal or inferior to 1 and, in a particular embodiment, the molar ratio is Ni/Al₂O₃ (spinel) is about ¼. In the catalyst, the spinel is distributed as nanometric grains in the ceramic support and the major part of the spinel is physically associated with the Al₂O₃ particles rather than YSZ particles.

The catalytically active phase NiAl₂O₄ can contain other elements such as and without being limitative CuO, MoO₃, and WO₃. In an embodiment, the catalytically active phase NiAl₂O₄ is substantially free of other elements, i.e. it contains no other elements except inevitable impurities.

The main products of hydrocarbonaceous fuel reforming, such as propane, hexadecane, diesel, and biodiesel reforming, are H₂, carbon monoxide (CO), and carbon dioxide (CO₂). Equation (3) is the core reaction of steam reforming and equation (4) is the water gas shift (WGS), a secondary reaction.

CₙHₘ+nH₂O→nCO+(n+m/2)H₂(ΔH>0) (3)

CO+H₂O→CO₂+H₂(ΔH>0) (4)

Catalyst Preparation

The Al2O3-YSZ-supported NiAl2O4 catalyst tested was prepared by a wet impregnation method. An Al2O3 (mixture of amorphous and γ-Al2O3) and YSZ (Y2O3-ZrO2—about between 1 w/w % and 2 w/w % of yttria) support was prepared by mechanically mixing equal quantities of the two powders together. Two Al2O3 powder sizes were studied: NiAl2O4/Al2O3-YSZ-1 at 20 nm to 40 nm and NiAl2O4/Al2O3-YSZ-2 at 40 μm. YSZ powder size distribution had an upper limit at 20 μm. The Al2O3 and YSZ powder mixture was impregnated with a Ni(NO3)2.6H2O aqueous solution, targeting a 5 w/w % nickel (Ni) load in the final formulation. Water was evaporated, and the resulting impregnated powder was dried overnight at 105-110° C. The resulting powder was crushed-comminuted and calcined at 900° C. for 6 hours to form the NiAl2O4 spinel. This procedure leads to nitrates decomposition and formation of the spinel phase. All nickel should be converted to its spinel form; there must remain substantially no residual metallic nickel or free Ni oxides.

One skilled in the art will appreciate that the process for preparing the Al₂O₃-YSZ-supported NiAl₂O₄ catalyst can vary. Moreover, the above-described embodiment for preparing the catalyst can also vary. For instance and without being limitative, the sintering temperature and time can change. For instance, the sintering temperature can be carried out between 900° C. to 1200° C. during few minutes to several hours. The sintering process can also be carried out by plasma or by any other appropriate technique.

The catalysts were analyzed by scanning electron microscopy (SEM) Hitachi S-4700 field emission gun and energy-dispersive X-ray spectroscopy (EDXS) Oxford EDXS detector with an ultra-thin ATW2 window. Both fresh and used catalysts were subjected to Philips X'Pert Pro X-ray diffractometry (XRD), employing a monochromator with radiation Cu Kα1, 40 mA current and voltage of 45 kVs. Chemical surface analysis was completed by X-ray photoelectron spectroscopy (XPS) in an Axis Ultra DLD of Kratos Analytical Equipment with A1 Kα monochromatic X-ray source. Calibration of the curve was based on the contaminant carbon.

The catalyst formulation was analyzed using XPS surface analysis, XRD analysis, and SEM analysis. The targeted catalyst form is a NiAl₂O₄ spinel on the surface of an alumina support without any metallic nickel or nickel oxide, i.e. the catalyst is substantially free of metallic nickel and nickel oxide, i.e. it contains no metallic nickel and nickel oxide except inevitable impurities.

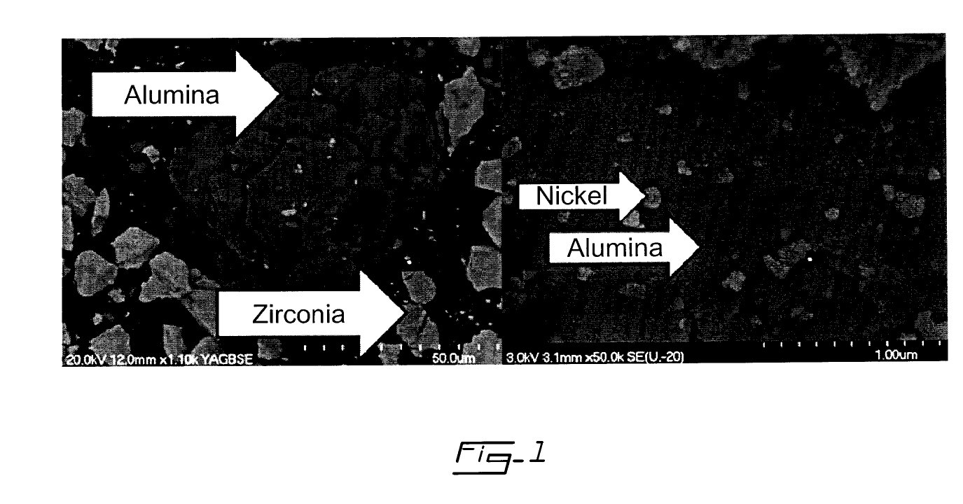

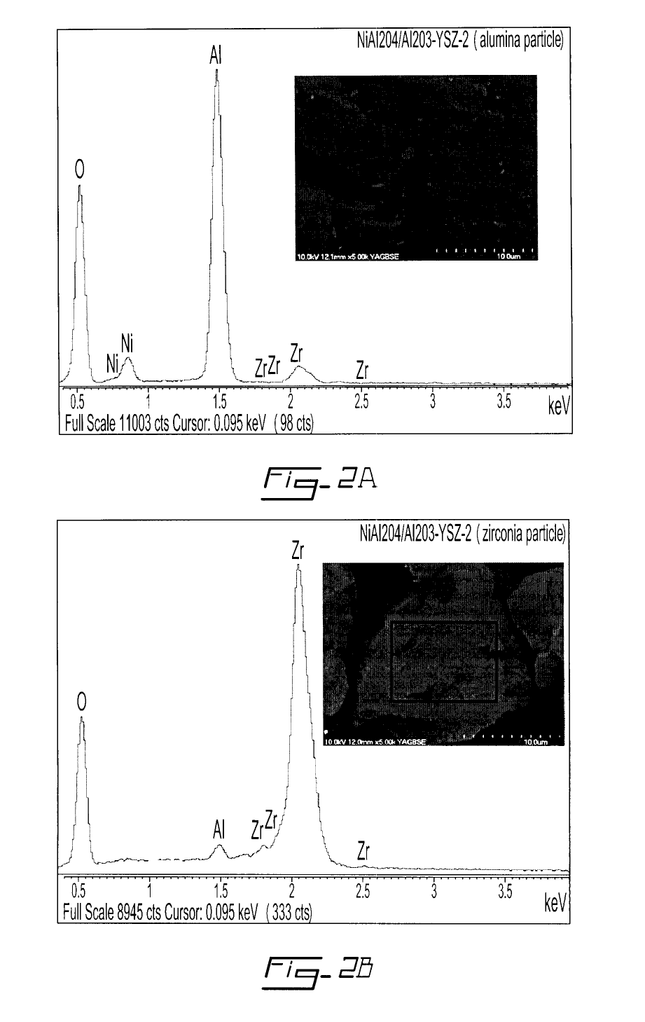

Surface SEM and SEM-EDXS analyses of the fresh catalyst are shown in FIGS. 1 and 2. FIG. 1 shows that a spinel catalyst support is composed of two types of distinct particles (grains) with distinct size distribution, those rich in alumina and those rich in YSZ. The smaller particles typically smaller than 20 μm are identified as the YSZ component, as confirmed by the EDX spectra (FIG. 2b). The larger particles are assigned to the alumina-bearing phase (typically 40-50 μm). SEM-EDXS analysis of these two types of grains presented in FIG. 2 with the corresponding SEM micrographs revealed that Ni was confined exclusively to alumina grains.

The route to build NiAl₂O₄ in the catalyst includes a NiO formation step, as shown in equations (5) and (6).

xNi(NiO₃)₂.6H₂O+yAl₂O₃→xNiO+yAl₂O₃+Gas (5)

xNiO+yAl₂O→xNiAl₂O₄+yAl₂O₃ (6)

It was important to ensure that reaction 6 was completed and the resulting catalyst is substantially free of NiO. Two simple tests were used to rule out the existence of NiO. First, NiO is green, while the catalyst gives a blue tint to the white Al₂O₃/YSZ mixture; this is typical to NiAl₂O₄. Second, the catalyst is resistant to chlorhydric (HCL) and nitric (HNO₃) acid solutions while NiO is completely digested (dissolved) by these strong acids.

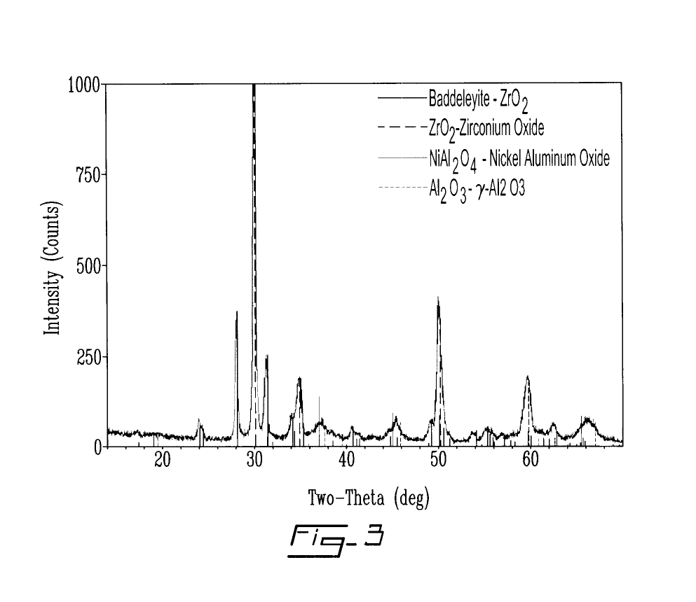

The XRD pattern shown in FIG. 3b is dominated by the YSZ. The absence of NiO peaks is another indication that NiO is not formed. The other features of the XRD pattern are constituted by weak and broad peaks which are likely assigned to the mixture of low crystallinity γ-Al₂O₃ (FIG. 3b). γ-Al₂O₃ and NiAl₂O₄ both share the same Bravais lattice with similar lattice parameters making them difficult to differentiate; especially when the diffraction lines are broadened.

The formation of the NiAl₂O₄ is confirmed from the analysis of the Ni L₂₃ edge obtained from the XPS of the catalyst formulation. The main features (L₃ peak position, L₂-L₃ energy separation, position of satellite peaks) are consistent with typical Ni L₂₃ edges associated to NiAl₂O₄ (Rivas, M. E., Fierro, J. L. G., Guil-LOpez, R., Pena, M. A., La Parola, V, and Goldwsser, M. R. (2008). Preparation and characterization of nickel-based mixed-oxides and their performance for catalytic methane decomposition. Catalysis Today 133-135: 367-373; Osaki, T. and Mori T. (2009). Characterization of nickel-alumina aerogels with high thermal stability. Journal of Non-Crystalline Solids: 1590: 1596). Furthermore, the position of the Ni 2p3/2 peak for NiO is found at a typically lower binding energy (around 855 eV). This confirms the absence of formation of NiO from the spinel catalyst.

Reactor Design

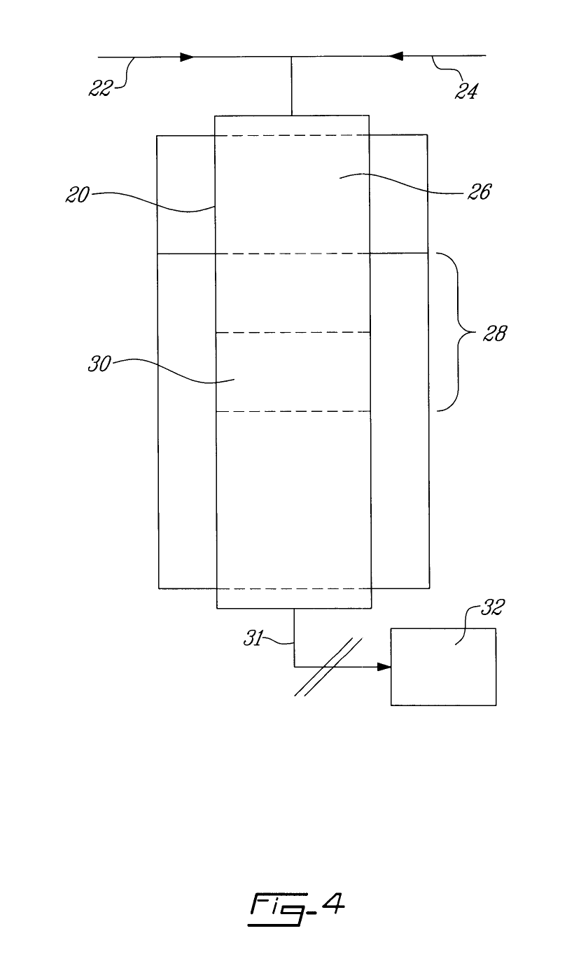

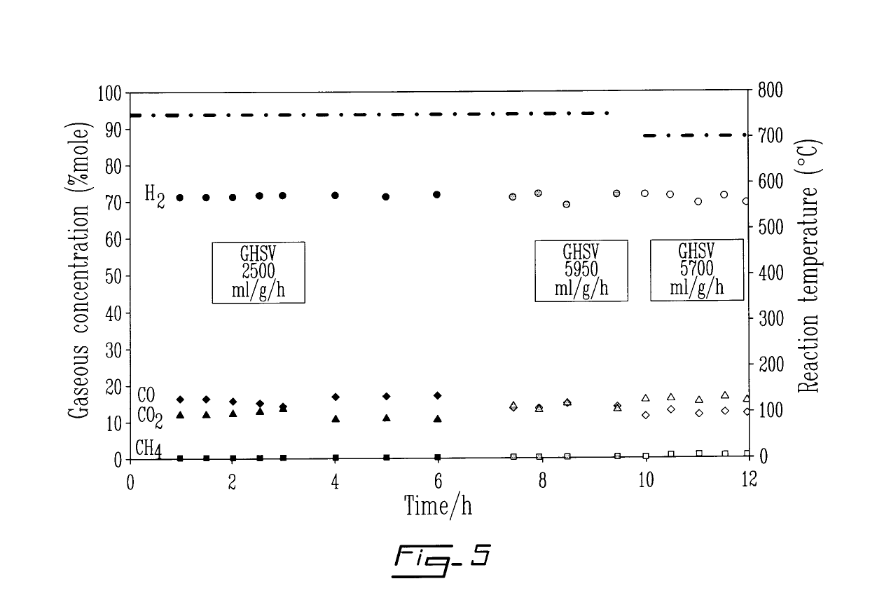

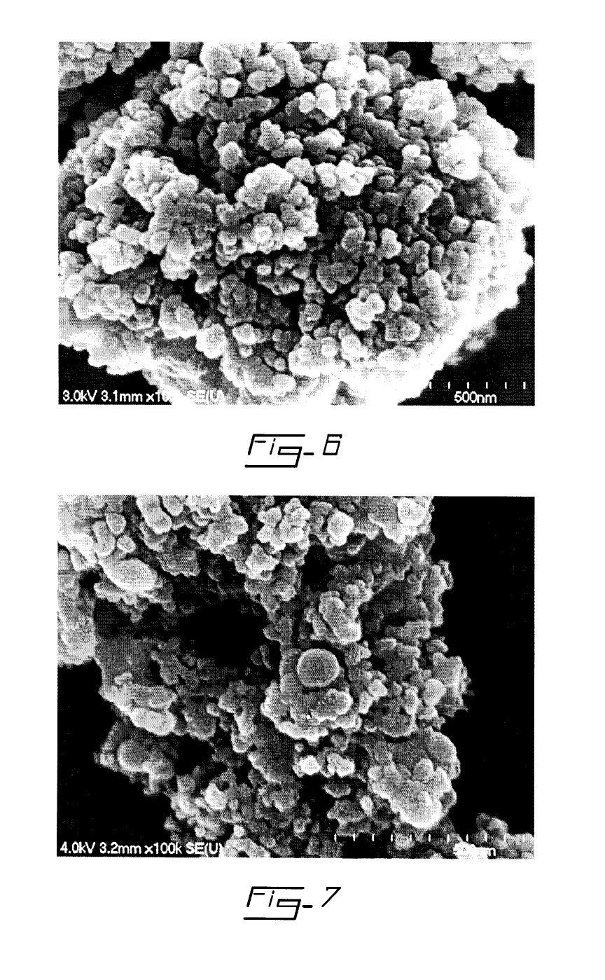

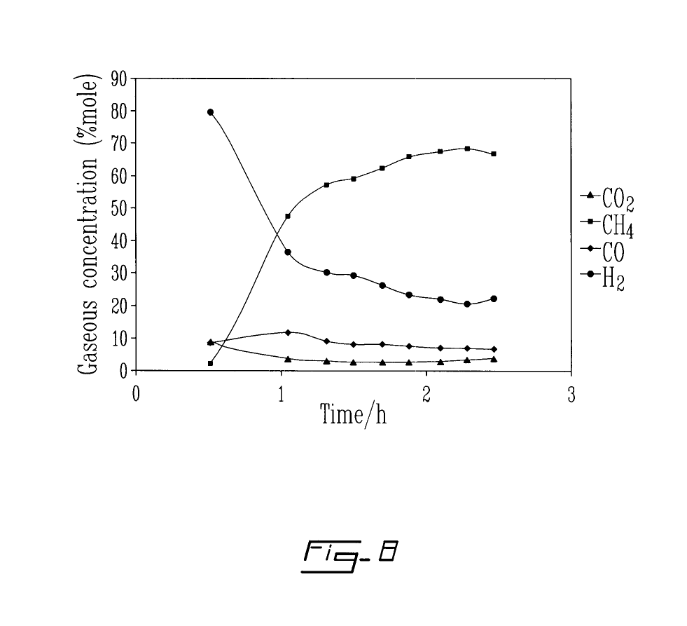

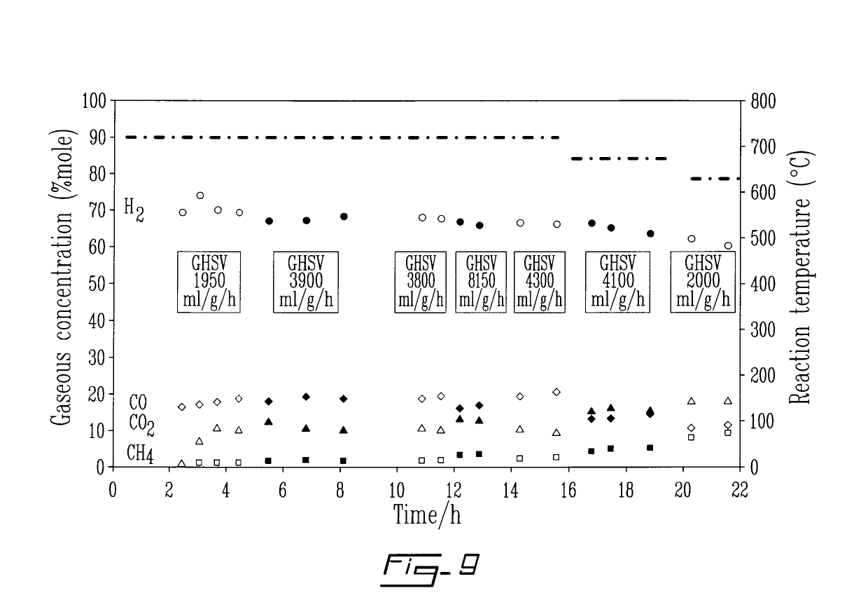

A schematic representation of the reactor 20 is presented at FIG. 4. The reactor 20 is a lab-scale isothermal differential packed & fixed bed reactor. The reactant mixture 22 and an inert gas 24 enter the reactor 20 into a pre-heating zone 26 located in the upper section of the housing. During steam reforming, the pre-heating zone 26 is characterized by a pre-heating temperature (T_{P-H}). The pre-heating zone 26 ensures mixing of the reactant mixture prior to its entrance in the lower section of the reaction zone 28. The catalyst is disposed in the catalytic zone 30 which is located in the reaction zone 28. The reaction zone 28, including the catalytic zone 30, is characterized by a reaction temperature (T_{R}). The product mixture 31 exits the reactor 20 and is directed to and analyzed with a Varian CP-3800 gas chromatograph 32. The exit gaseous flow rate was measured using a mass flow rate mass meter (Omega FMA-700A). In the embodiment used, the reactor diameter was 46 mm and the catalytic bed was 60 mm.

The catalyst in powder from was dispersed in quartz wool. The quartz wool was then compacted in the reactor 20 to form a catalytic bed of quartz fibre containing catalyst particulates. Since the reactant mixture gas flow entering the bed comes from an injecting device, it is highly turbulent and does not have enough time to become fully developed. This configuration prevents channelling issues and helps obtaining a uniform catalytic bed with the small amount of catalyst used.

The reactor design should allow an as complete as possible mixing of the reactant mixture, i.e. hydrocarbonaceous fuels and water, prior to the entrance in the reaction zone 28. It should also allow liquid preheating/vaporization/gas preheating of the reactant mixture 22 in conditions to minimize undesirable carbon forming cracking reactions.

Since hydrocarbons are not miscible with water and if the above mentioned constraints are not respected, hydrocarbons pyrolysis takes place prior to the reaction in the preheating section (Liu, D., M. Krumpelt, H. Chien and S. Sheen (2006). Critical issues in catalytic diesel reforming for solid oxide fuel cells. J. Mater. Eng. Perform., Vol. 15, n° 4, p. 442-444).

The reactor can be fed by vaporization or atomization. Atomization typically limits thermal cracking. Furthermore, by decreasing the size, and therefore increasing the surface of each droplet, a better water/hydrocarbons mixing is obtained prior to heating and a better pre-mixing of the reactant mixture lowers the thermal cracking reactions occurrence (Liu et al., 2006). This can be carried out, for instance and without being limitative, with ultrasons-enhanced or other commercial diesel engines injectors (Kang, I., J. Bae, S. Yoon and Y. Yoo (2007). Performance improvement of diesel autothermal reformer by applying ultrasonic injector for effective fuel delivery. J. Power Sources, Vol. 172, n° 2, p. 845-852; Liu et al., 2006).

In the below described examples, the reactions are carried out at atmospheric pressure.

Conversion Calculations

Overall conversion was calculated for hydrocarbonaceous fuel reforming based on the total amount of carbon fed in the reactor. Hydrocarbonaceous fuels were considered to be converted when they were transformed into gaseous product mixture (CO, CO₂ or CH₄). Carbon found in the reactor after the experiment was therefore not considered as converted hydrocarbon (or hydrocarbonaceous fuel).

The experimental conversion (X) was calculated (7):

$$X = \frac{{N}_{{CO}_{out}} + {N}_{{CO}_{{2}_{out}}} + {N}_{{CH}_{{4}_{out}}}}{{N}_{{C}_{m} {H}_{{n}_{in}}} xm + {N}_{{surfactant}_{m}} xY} \qquad ( 7 )$$

With Nᵢ being the total number of moles of component i at the reactor exit or inlet, Y being the number of carbon atoms in the surfactant.

For the different reforming reactions, the reactor exit concentrations of H₂, CO, CO₂, CH₄ were compared to the theoretical thermodynamic equilibrium concentrations, in order to determine if the equilibrium was reached. Thermodynamic equilibrium concentrations calculations were calculated with FactSage software on the basis of Gibbs energy minimization.

Measurement Errors

Errors associated with concentration data obtained by gas chromatography are presented in Table 1. They were calculated by using an external standard.

In addition to the GC concentrations measurements errors, the mass flow meter used to measure the exit gas flow introduces a second error in the conversion calculations. The accuracy of the mass flow meter is 1 mol %.

Maximum and minimum values were therefore calculated for each conversion, using the extreme values for concentrations and flow rate based on the known error and accuracy.

TABLE 1
Gaseous concentrations measurement errors.

| | Standard gaseous | Absolute error (on % | Relative |
|---|---|---|---|
| Gas | concentration (mol %) | concentration of the standard) | error (%) |
| H₂ | 55.16 | 0.46 | 0.83 |
| CO | 19.70 | 0.21 | 1.05 |
| CO₂ | 6.96 | 0.38 | 5.45 |
| CH₄ | 2.08 | 0.04 | 1.87 |
| Ar | 16.10 | 0.22 | 1.37 |

Propane Reforming

Using the above described reactor and Ni—Al₂O₄ spinel catalyst, propane (C₃H₈) reforming was first performed. Propane was chosen because it is the simpler saturated hydrocarbon containing carbon linked chemically with two other carbon atoms.

Gaseous propane was mixed with 110° C. steam before entering the pre-heating zone, which was maintained at 750° C. The temperature just before the catalyst bed was between 30° C. and 45° C. below the reaction temperature, depending on the operating parameters. Argon served as inert diluent and internal standard for liquid hydrocarbonaceous fuel steam reforming. It is appreciated that other inert gases can be used.

Propane was reformed in the packed-bed reactor (PBR) 20. The reactor was heated to the desired temperature under an argon (Ar) blanket. The argon flow was switched off prior to feeding the reactant mixture. The reaction temperatures tested were 750° C. and 700° C., pressure was atmospheric or slightly higher due to the pressure loss along the PBR set-up, and the steam-to-carbon (H₂O/C) molar ratio was 3, i.e. there was a steam excess of 300 mol %. The gas hourly space velocity (GHSV) was between 2 900 and 5 950 cm³_{reac}g⁻¹_{cat}h⁻¹ under reaction conditions.

Hexadecane and Tetralin Reforming

Hexadecane reforming and tetralin reforming were performed to test the Ni-alumina spinel catalyst with paraffin and aromatic compounds. Hexadecane was chosen as a surrogate of diesel's paraffinic compounds and because it represents the average fossil diesel composition. Tetralin was selected as a representative of diesel's naphthenic and aromatic part.

For hexadecane and tetralin reforming, an emulsion, as explained below, entered at room temperature and was rapidly heated in the pre-heating zone maintained at a temperature between 400° C. and 500° C.

The method chosen to enhance the hydrocarbonaceous fuel/water mixing for hexadecane and tetralin reforming was the formation of an emulsion of two immiscible reactants in a surfactant-aided protocol.

In an embodiment, the emulsion was obtained by (1) magnetically stirring together oleic acid (90%, Alfa Aesar®), pentanol (99%, Fisher Scientific™), and the hydrocabonaceous fuel. (2) A solution of ammonium hydroxide (30%) was mixed with water. This solution (1) was added drop by drop to the mixture (2) whilst continuing magnetic stirring. When the entire water and ammonium hydroxide solution was integrated in the hydrocabonaceous fuel, stirring was maintained for few minutes.

Table 2, below, shows the percentage of the components used to prepare the emulsion. Depending on the hydrocarbonaceous fuel used, emulsions with H₂O/C ratio ranging between 2 and 2.5 can be obtained.

TABLE 2
Emulsion components.

| Component | Concentration (w/w %) |
|---|---|
| Oleic acid (90%) | 5.2 |
| Pentanol (99%) | 2.6 |
| Ammonium hydroxide solution (30%) | 0.7 |
| Water | 21.9 |
| Hydrocarbonaceous fuel | 69.6 |

This emulsion was heated and vaporized in the preheating zone before reaching the catalyst. The surfactant-stabilized emultion of hydrocarbonaceous fuel and steam was employed to maximize reactant mixing and prevent cracking reactions that lower reforming efficiency.

The PBR described above in reference to FIG. 4 with the catalyst dispersed in quartz wool was used for hexadecane and tetralin reforming. The H₂O/C ratio was 2.5 for hexadecane reforming and 2.3 for tetralin reforming. The reaction temperatures were between 630° C. and 720° C. with GHSV ranging from 1 900 to 12 000 cm³_{reac}g⁻¹_{cat}h⁻¹ at atmospheric pressure.

Results

Propane Catalytic Steam Reforming with the NiAl₂O₄/Al₂O₃-YSZ-1 Catalyst

The results of propane steam reforming using NiAl₂O₄/Al₂O₃-YSZ-1 catalyst are shown in FIG. 5. During the first 10 hours of reaction, the reaction temperature was kept constant at 750° C. For the last two hours, the reaction temperature was decreased to 700° C. The observed H₂ concentration was constant at 70 vol % for the 12 hours of operation, and methane concentration was below 1 vol % for the entire reaction time. There was no deactivation of the catalyst. The shift in the carbon monoxide (CO) and carbon dioxide (CO₂) concentrations with the decrease in temperature follows the predictions of the theoretical thermodynamic equilibrium calculations.

SEM pictures of the catalyst before and after the 12 hours of reaction are shown respectively in FIGS. 6 and 7. No carbon deposition on the catalyst was evident. The somewhat larger catalyst grains observed in FIG. 7 were explained by some sintering activity which was not, nevertheless, sufficient to lower the activity under reaction conditions. These results being positive, the catalyst was then tested on hexadecane steam reforming.

Hexadecane Catalytic Steam Reforming without a Catalyst

The results of a blank experiment are illustrated in FIG. 8. This blank experiment was performed without catalyst but with quartz wool as inert bed in the PBR, at a temperature of 710° C., a flow rate of 22 700 cm³ h⁻¹, and a H₂O/C molar ratio of 2.5. The concentrations corresponded to cracking, and no reforming reaction took place in the reactor without the catalyst. A major part of hexadecane was transformed into coke in the reactor, and conversion, as defined in Eq. 7, was only 25 w/w %.

In addition to this blank experiment, an experiment at 650° C. has been done aimed at measuring the concentration of the gas just before entering the catalytic zone. The concentrations of the gaseous product mixture (at 25° C.) are presented in Table 3. The conversion as defined by Eq. 7 was only of 6 w/w°/0. The hexadecane conversion including the ethane, ethylene, propane and butane in the calculation was 42 w/w %. The rest of the reactant mixture was collected as condensed liquid phase at the exit of the reactor.

TABLE 3
Thermal cracking of hexadecane with a H₂O/C molar ratio =
2.5:Gas product mixture composition at 25° C.

| Product mixture | Gaseous concentration (% mole) |
|---|---|
| CO₂ | 1.4 |
| CO | 3.2 |
| H₂ | 8.1 |
| CH₄ | 19.7 |
| C₂H₄ | 46.2 |
| C₂H₆ | 4.5 |
| C₃H₈ | 15.4 |
| C₄H₁₀ | 1.5 |

Hexadecane Catalytic Steam Reforming with the NiAl₂O₄/Al₂O₃-YSZ-1 Catalyst

The results of hexadecane steam reforming with the NiAl₂O₄/Al₂O₃-YSZ-1 catalyst are shown in FIG. 9. The catalyst was used for 22 hours under different GHSV and three different temperatures. 720° C., 675° C., and 630° C., with a H₂O/C molar ratio of 2.5.

Surface SEM analysis of the catalyst is shown in FIG. 10. As in the propane reforming test, there was no carbon deposition. The extent of the sintering seemed higher. This could be linked to longer test durations (22 hours instead of 12 hours for propane), but since the temperature was lower, it is rather difficult to draw safe conclusions based only on these preliminary qualitative findings. However, no deactivation of the catalyst was due to this small extent of sintering.

Hexadecane Catalytic Steam Reforming with the NiAl₂O₄/Al₂O₃-YSZ-2 Catalyst

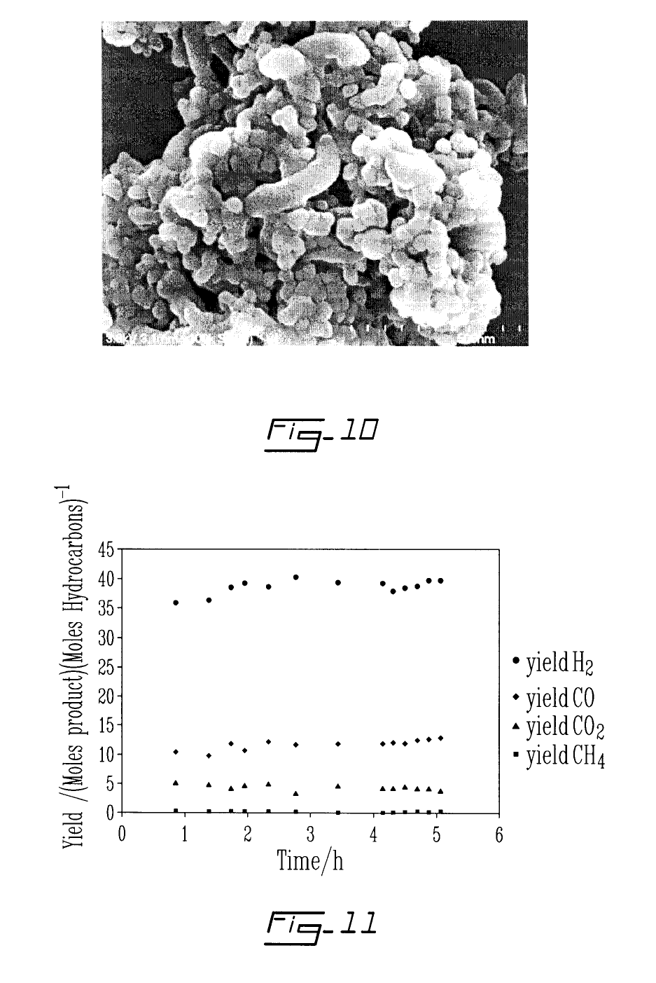

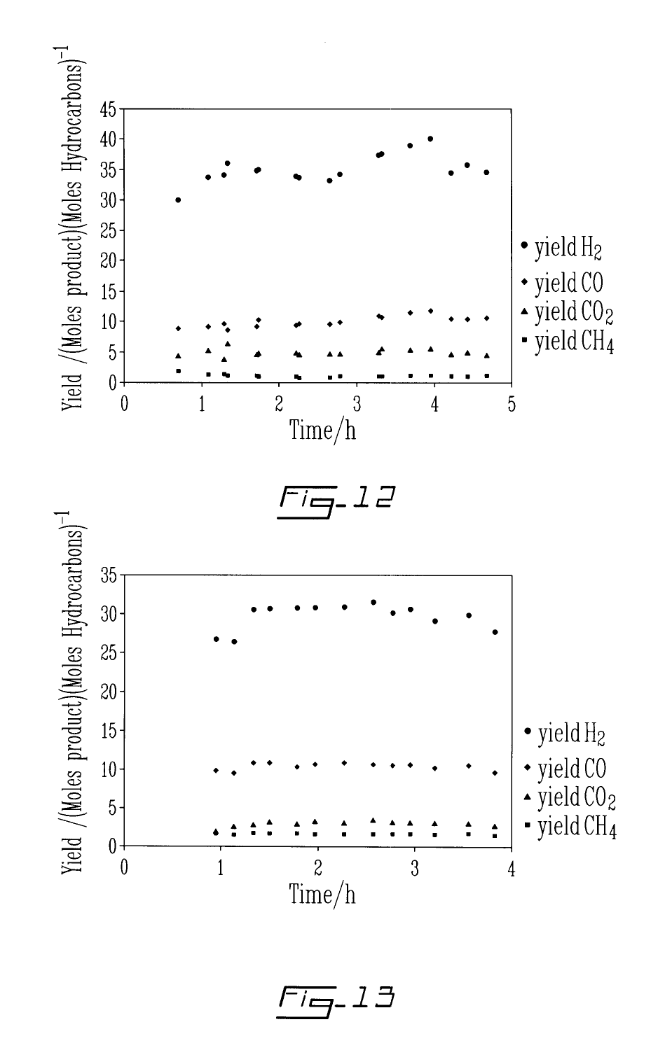

The results of three experiments on hexadecane steam reforming with the NiAl₂O₄/Al₂O₃-YSZ-2 catalyst are shown in FIGS. 11 to 13. The catalyst was tested under three different sets of operating conditions reported in Table 4.

TABLE 4
Operating conditions for hexadecane steam reforming
with the NiAl₂O₄/Al₂O₃—YSZ-2 catalyst.

| Run | A | B | C |
|---|---|---|---|
| GHSV (cm³g⁻¹h⁻¹) | 5 000 | 4 800 | 12 000 |
| Entrance temperature (° C.) | 655 | 648 | 645 |
| Reaction temperature (° C.) | 710 | 670 | 670 |
| H₂O/C ratio (mol/mol) | 2.5 | 2.5 | 2.5 |

It can be observed from experiments A-C that the concentrations of the product gas mixture were stable and consequently there was no catalyst deactivation observed. However, there was a slight difference in the concentrations of experiments B and C, even if they were performed at the same temperature. This indicates that an increase of the GHSV from 5 000 cm³_{react}g_{cat}⁻¹h⁻¹ to 12 000 cm³_{react}g_{cat}⁻¹h⁻¹ at a temperature of 670° C. had an effect on the reaction. In addition, conversion decreased at the higher GHSV. The calculated conversions are presented in Table 5. The difference in calculated conversions between experiments A and B is of the order of magnitude of the systematic error associated with the measurements precision. The confidence intervals show that the conversion is statistically the same for both experiments. Moreover, as explained in more details below, concentrations are at equilibrium. Finally, the decrease of temperature by 40° C. does not have a significant impact on conversion (comparison of experiments A and B).

TABLE 5
Calculated conversions for hexadecane steam reforming
with the NiAl₂O₄/Al₂O₃—YSZ-2 catalyst.

| Run | A | B | C |
|---|---|---|---|
| Conver- | 0.94 (0.908-0.970) | 0.97 (0.938-0.996) | 0.86 (0.839-0.889) |
| sion | | | |

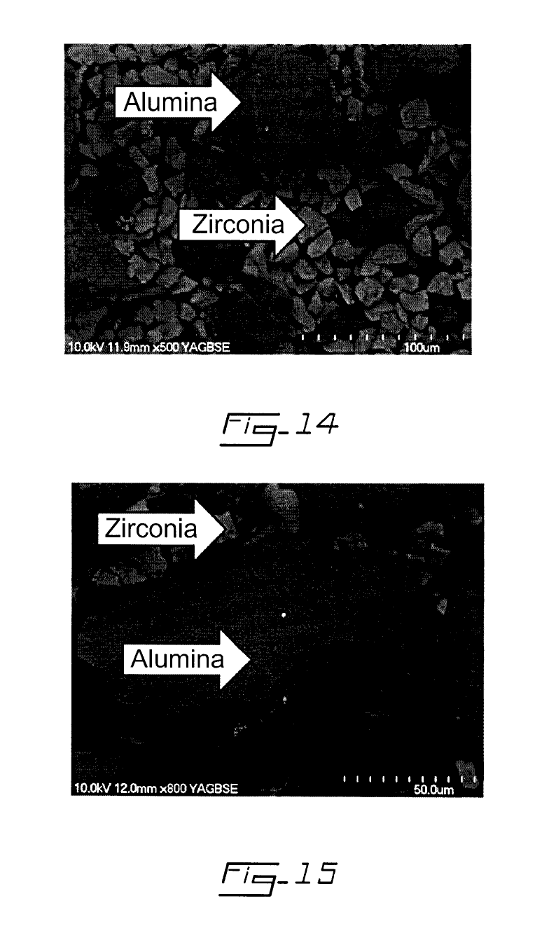

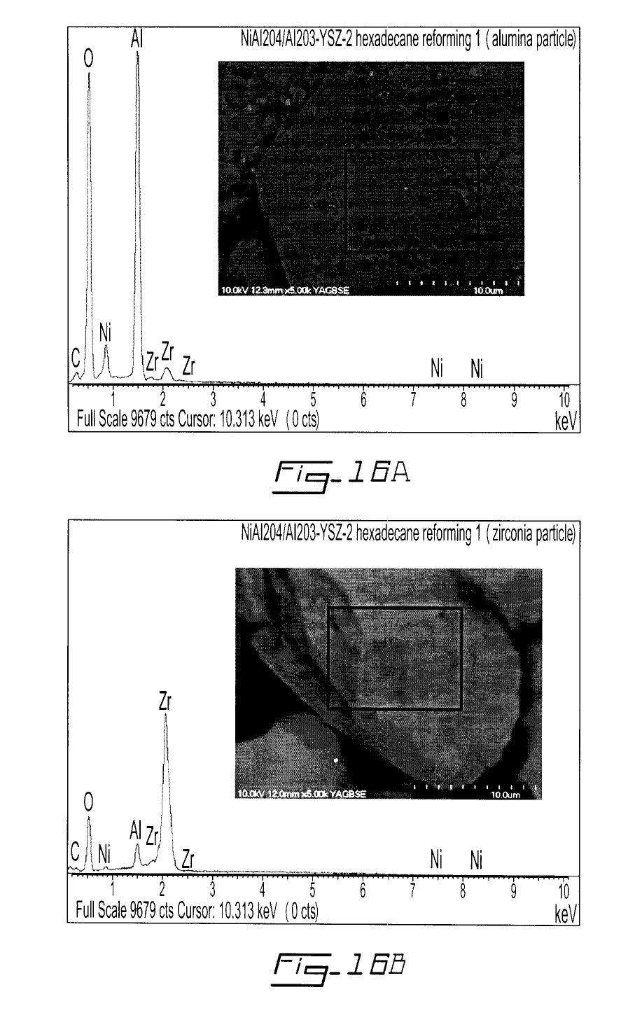

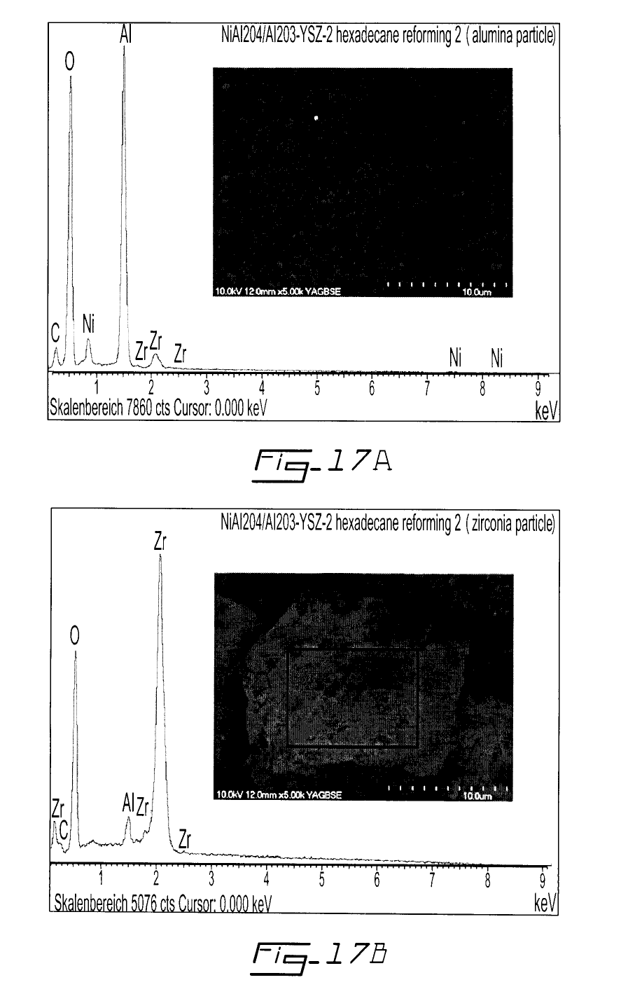

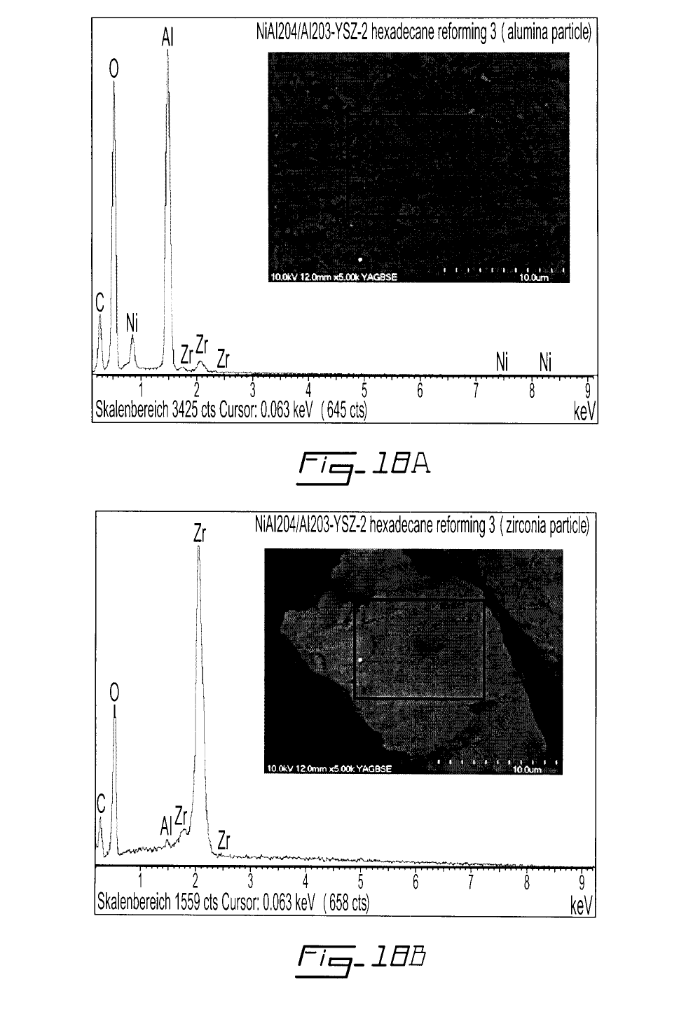

SEM pictures of the catalyst after its use in experiments A and C are shown in FIGS. 14 and 15, respectively. There is no apparent change in the morphology of the support and no sintering was observed. SEM-EDXS analyses with the associated SEM picture of the NiAl₂O₄/Al₂O₃-YSZ-2 catalyst after its use in the three hexadecane experiments are shown in FIGS. 16 to 18. Small quantities of graphitic carbon appear to be deposited only on the catalyst used in experiment C; no carbon nanofibers were observed.

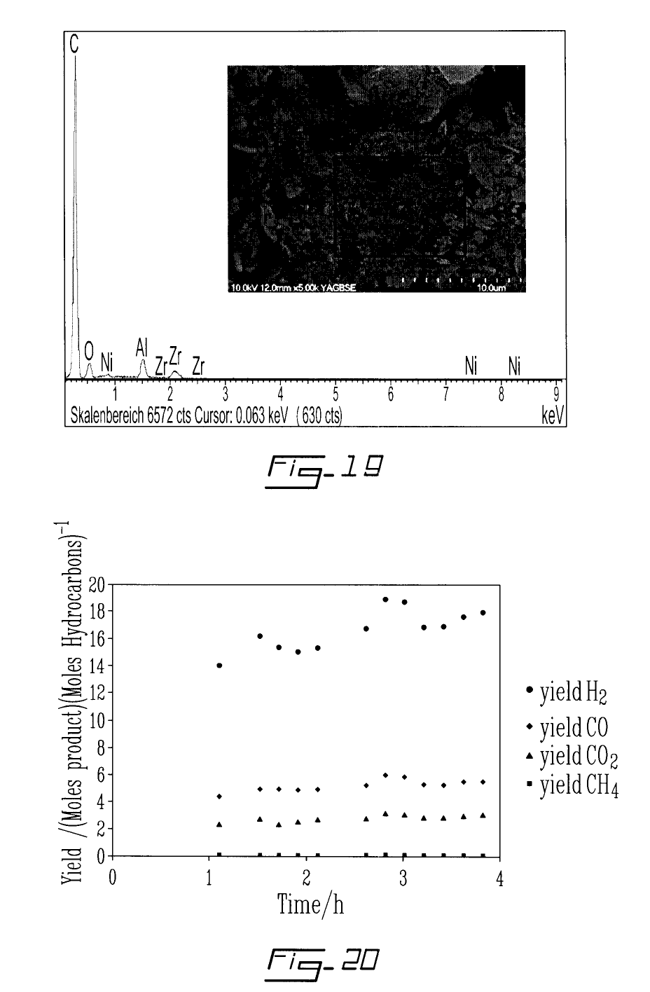

FIG. 19 presents the SEM-EDXS analysis of a catalyst made of metallic nickel deposited on the same substrate instead of the spinel. The mass compositions of the two catalysts were the same and the experiment took place at lower GHSV but all other operation conditions of experiment C were kept identical. The conversion was lower (0.76) and FIG. 19 shows that there is a significant amount of carbon deposit on the catalyst including carbon nanofibers. This is a significant proof of the spinel improved capacity to steam reform without favoring carbon formation and deposition.

Table 6 presents the BET analysis of the NiAl₂O₄/Al₂O₃-YSZ-2 catalyst before and after experiment C. After the experiment, the catalyst was mechanically sorted out of its quartz wool matrix; however, some quartz wool remained with the catalyst. The quartz wool contribution in the BET analysis is insignificant (BET analysis of the quartz wool sample shows no measurable specific surface), but it is part of the mass of the sample. The results show that there is a relatively significant increase of the BET surface in the used catalyst. This leads to the conclusion that there is no measurable sintering; this fact is supported by the SEM analysis. At least a part of the BET specific surface increase can be attributed to catalyst grains breakage, also observed by SEM. Another part could be associated with the experimental error due to the possibility of having different quartz wool mass percentages in the measured samples.

TABLE 6
BET surface area analysis of the NiAl₂O₄/Al₂O₃—YSZ-2 catalyst.

| Catalyst | BET (m² g⁻¹) |
|---|---|
| Fresh | 35.0 |
| After experiment C | 44.8 |

Tetralin Catalytic Steam Reforming with the NiAl₂O₄/Al₂O₃-YSZ-2 Catalyst

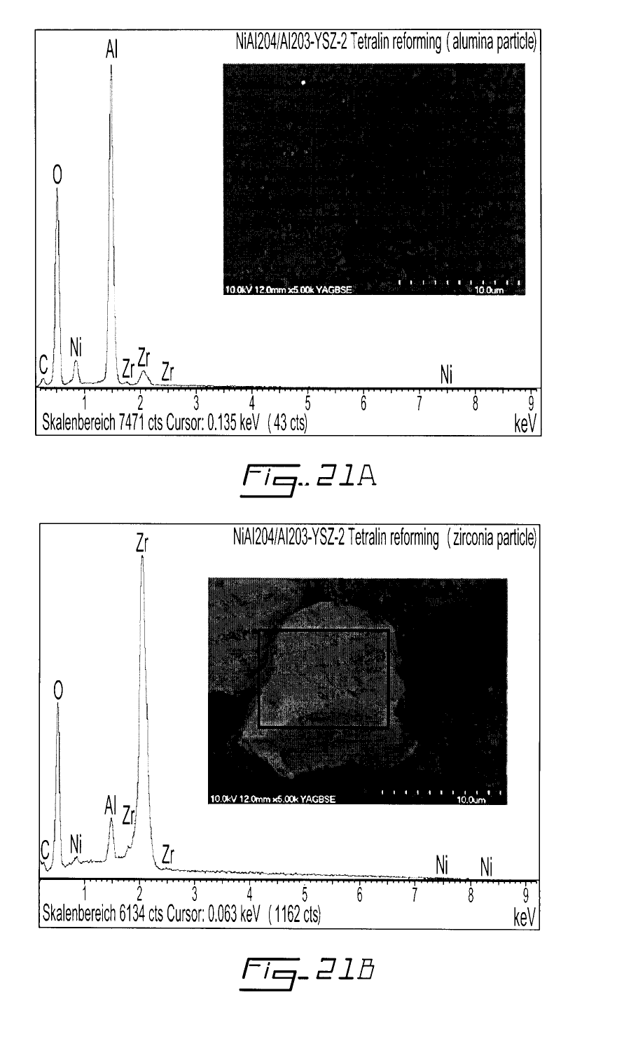

The results obtained for tetralin steam reforming with the NiAl₂O₄/Al₂O₃-YSZ-2 catalyst are shown in FIG. 20. The catalyst was used under a GHSV of 4800 cm³_{react}g_{cat}⁻¹h⁻¹, an entrance temperature of 670° C., a reaction temperature of 705° C. with a H₂O/C molar ratio of 2.3. The conversion obtained was 0.69 (0.668-0.715), explained by the higher refractory behavior of cyclic/aromatic compounds in reforming reactions. Gaseous concentrations at the reactor exit were, however, stable, with no deactivation of the catalyst. The BET surface of the catalyst after the experiment was 40.0 m² g⁻¹, which is consistent with the observed behavior in hexadecane reforming.

SEM-EDXS analysis with the associated SEM picture of the NiAl₂O₄/Al₂O₃-YSZ-2 catalyst is shown in FIG. 21. There is no significant carbon deposition and the NiAl₂O₄/Al₂O₃-YSZ-2 catalyst after use in the tetralin experiment results are similar to those obtained with the hexadecane reforming at similar conditions (experiment B).

Discussion

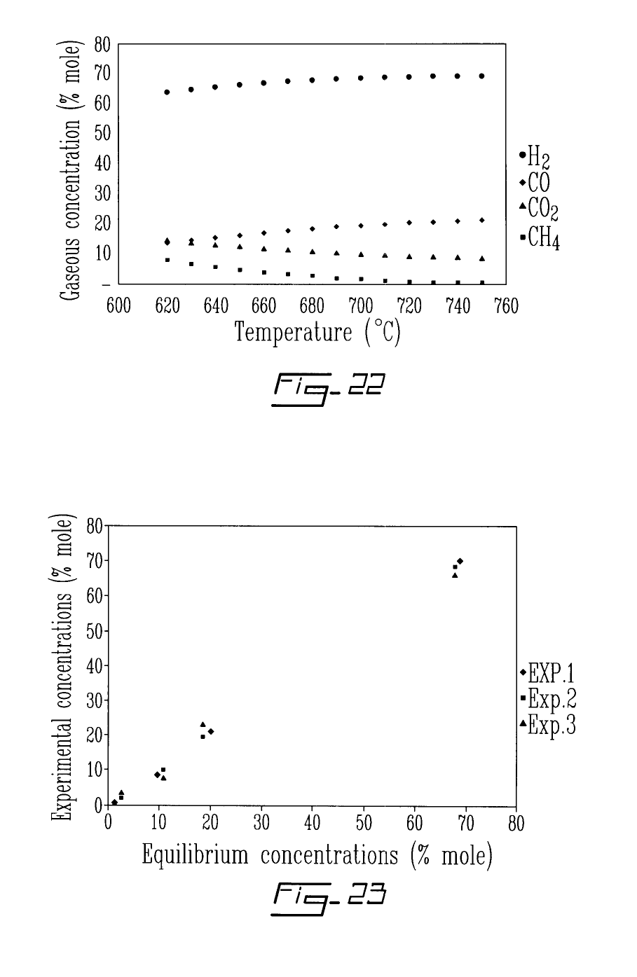

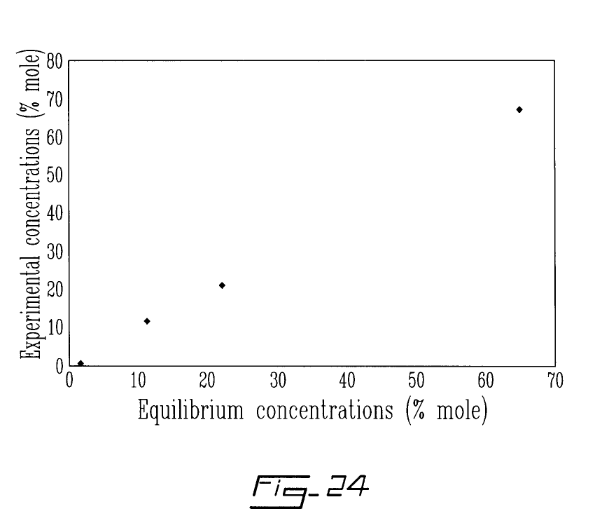

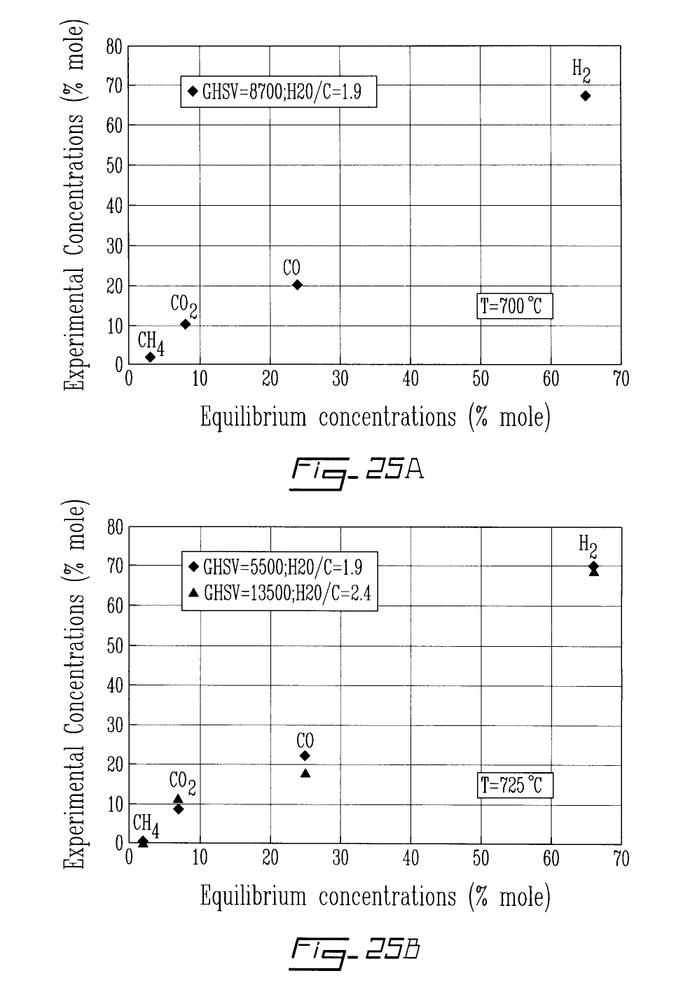

For hexadecane steam reforming with the NiAl₂O₄/Al₂O₃-YSZ-1 catalyst, and for the entire duration of the reaction, the concentrations of H₂, CO, CO₂ and CH₄ were all near the values predicted from theoretical thermodynamic equilibrium calculations. Product concentrations were still close to equilibrium, even if lower temperatures decreased the rate of reforming reactions and thermodynamically favored carbon formation and deposition through the Boudouard reaction. The equilibrium concentrations for hexadecane steam reforming appear in FIG. 22. Comparisons between theoretical equilibrium concentrations and experimental concentrations are shown in FIG. 23 for hexadecane and FIG. 24 for tetralin with the NiAl₂O₄/Al₂O₃-YSZ-2 catalyst. It can be seen that the experimental concentrations were similar to theoretical equilibrium concentrations. For experiment C, at higher GHSV, the concentrations were slightly different; these conditions were thus considered as the limit to operate within equilibrium conditions.

Biodiesel Reforming

Biodiesel reforming can be represented by the following global reaction (8):

C₁₈H₃₆O₂+16H₂O→18CO+34H₂(ΔH>0) (8)

As mentioned before, an emulsion-in-water technique was adopted for biodiesel injection. This method was chosen to enhance hydrocarbonaceous fuel/water mixing. The two immiscible reactants were emulsified according to the surfactant-aided protocol described above. The reactant mixture entered at room temperature and was rapidly heated and vaporized in the pre-heating zone 26 (FIG. 4) maintained at 550° C. The temperature just before the catalyst bed was between 30° C. and 45° C. below the reaction temperature, depending on operating parameters. Argon served as inert diluent and internal standard for liquid hydrocarbonaceous fuel steam reforming.

The water to steam molar (H₂O/C) ratio was varied between 1.9 and 2.4. Reaction temperatures were 700° C. and 725° C. with GHSV ranged from 5 500 and 13 500 cm³_{react}g_{cat}⁻¹h⁻¹ at atmospheric pressure. Biodiesel, from used vegetable oil, was produced by a transesterification process developed by Biocarburant PL (Sherbrooke, Qc, Canada; www.biocarburantpl.ca).

The same packed-bed reactor, as described above, was used for carrying out the steam reforming.

Table 7 lists the conditions for three different biodiesel reforming test runs with the associated overall conversion calculated.

TABLE 7
Biodiesel reforming test runs description

| Run | A | B | C |
|---|---|---|---|
| Temperature (° C.) | 700 | 725 | 725 |
| Catalyst weight (g) | 5.0 | 3.0 | 3.0 |
| Run time (h) | 3 | 4 | 2 |
| GHSV (cm³g⁻¹h⁻¹) | 8 700 | 5 500 | 13 500 |
| H₂O/C* (mol/mol) | 1.9 | 1.9 | 2.4 |
| Conversion (±3%) | 88 | 100 | 85 |

*Steam-to-carbon (H₂O/C) molar ratio calculated, including surfactant

Dry gaseous concentrations in product mixture are presented in FIG. 25. Concentrations were stable for the entire reaction time with no catalyst deactivation noted.

With a temperature increase and flow rate decrease, 100% conversion can be reached. Furthermore, an increase of GHSV decreases conversion, even at a higher H₂O/C molar ratio. This reduction of conversion was associated with concentrations not being exactly at equilibrium. FIG. 25 compares the theoretical equilibrium and experimental concentrations of the dry gas at the reactor exit.

These data are indicative of the ability of the Al₂O₃/YSZ-supported NiAl₂O₄ spinel catalyst to efficiently steam reform commercial biodiesel. The catalyst is not poisoned by sulfur since the latter is not present in biodiesel in detectable quantities, and since carbon formation is insignificant, the only remaining catalyst deactivation mechanism is sintering. Thus, the expected life cycle of the NiAl₂O₄ catalyst is considerably longer than any other metallic Ni-based formulation.

High GHSV, which gave complete biodiesel conversion, are indicative of a rather surface reaction kinetics-controlled process.

Concentrations for run B were equal to those at chemical thermodynamic equilibrium. In run A, even if the conversion was not complete, the concentrations were near equilibrium. It should be noted that for biodiesel reforming below 700° C., theoretical equilibrium concentrations predict the presence of significant amounts of methane and coke formation if the H₂O/C molar ratio in the reactant mixture is not higher than stoichiometric ratio.

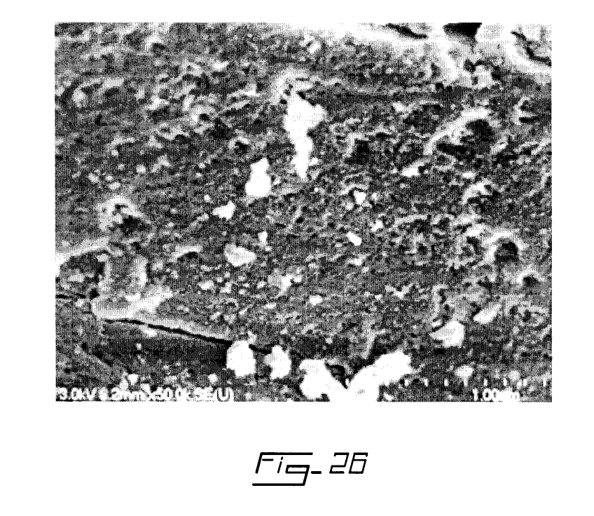

The used catalyst was also analyzed by SEM. SEM pictures proved that there were not significant carbon deposits on the surface. Some carbon whiskers were found on less than 5% of the surface; this was, however, expected because local nanoheterogeneities and the possibility that some MO on the surface was not transformed into NiAl₂O₄ which could form Ni during SR reactions. FIG. 26 shows the SEM micrograph of an Al₂O₃ particulate of the NiAl₂O₄ catalyst employed in run B of the biodiesel reforming test.

The Al₂O₃/YSZ-supported NiAl₂O₄ catalyst has been tested efficiently in biodiesel steam reforming. 100% conversion was obtained at relatively low severity conditions. Increasing GHSV above 10 000 (cm³g⁻¹h⁻¹) decreased conversion, but dry concentrations of the exit gas were still near equilibrium. No catalyst deactivation was encountered. There was no observable carbon on the surface of the catalyst used in these conditions, event with a H₂O/C molar ratio lower than 2.

### CONCLUSION

A Ni-alumina spinel supported on an Al₂O₃-YSZ ceramic matrix was developed as a catalyst for steam reforming of carbonaceous fuels including hydrocarbons, diesels, and the like.

Reactants feeding as a stabilized hydrocarbon-water emulsion proved to be efficient and prevented undesired pre-cracking.

Nickel-based catalysts offer a low-cost, effective option for steam reforming. Compared to conventional nickel catalysts which deactivate rapidly mainly due to coking, the spinel catalyst NiAl₂O₄/Al₂O₃-YSZ is stable, i.e. it has an improved resistance to carbon formation and therefore a longer catalyst lifetime. Furthermore, the results showed that the spinel catalyst is efficient for steam reforming of hydrocarbonaceous fuel(s). There was no significant coking on the active part of the catalysts, even at high reaction severities.

With the reactor design used and the above-described method for feeding the reactant mixture, conversion rates as high as 100% were achieved with high H₂ concentration as summarized in Table 8 below. Moreover, the product mixture concentrations are close to equilibrium and constant over time for durations up to about 20 hours. Regarding the operating conditions, the GHSV for reaching equilibrium are equal or higher than those found in the literature at equal or higher reaction severities (temperature).

TABLE 8
Steam reforming parameters in the presence of the
NiAl₂O₄/Al₂O₃-YSZ catalyst.

| | | | | | | Carbon |
|---|---|---|---|---|---|---|
| | | | | Con- | | formation |
| | | Ratio | GHSV | version | H₂ | observed |
| Fuel | T (° C.) | H₂O/C | (cm³g⁻¹h⁻¹) | (%) | (%) | by SEM |
| Propane | 700-750 | 3 | 2 500-5 950 | 100 | 70 | None |
| Hexa- | 670-710 | 2.5 | 4 800-12 000 | 86-97 | 65-70 | None |
| decane | | | | | | |
| Tetralin | 630-720 | 2.3 | 1 900-12 000 | 69 | 60-70 | Minimal |
| Biodiesel | 710 | 1.9-2.4 | 5 500-13 500 | 85-100 | 60-70 | Minimal |
| Diesel | 695-710 | 1.9 | 4 500-52 000 | 79-93 | 63-70 | None |

The above-described catalysts and process can be used for steam reforming of biodiesel, a renewable energy carrier.

The catalysts and the steam reforming processes using same can be used for the production of high concentrations of H₂. The H₂ produced can be used, for instance and without being limitative, for refineries and petrochemical processes (e.g. fossil fuels processing, ammonia production) and SOFCs targeting stable, clean, chemical-to-electrical energy conversion applications.

The product gas mixture mainly composed of H₂ and CO (synthesis gas) can be used directly as SOFC fuel.

The reaction conditions, including and without being limitative, the temperature, the pressure, the steam-to-carbon ratio (H₂O/C ratio), and gas hourly space velocity (GHSV), can be optimized for the steam reformed hydrocarbons such as methane, propane, hexadecane, tetradecane, diesel, and the like.

Several alternatives can be foreseen. For instance and without being limitative, the reaction temperature for the steam reforming process can range between 500° C. and 900° C., in an embodiment, they can range between 600° C. and 750° C.; and in a particular embodiment, they can range between 630° C. and 720° C. The reactant mixture has a H₂O:carbon molar ratio between 2.3 and 3; in an embodiment between 2.3 and 2.8, and in a particular embodiment about 2.5. The steam reforming process is carried out with a gas hourly space velocity (GHSV) ranging between 300 cm³g⁻¹h⁻¹ and 200 000 cm³g⁻¹h⁻¹ and in an embodiment between 900 cm³g⁻¹h⁻¹ and 52 000 cm³g⁻¹h⁻¹.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A process for steam reforming of a hydrocarbonaceous fuel, comprising the steps of:
providing a reactant mixture comprising H₂O and the hydrocarbonaceous fuel; and
contacting the reactant mixture with a Al₂O₃-yttria-stabilized ZrO₂ (YSZ)-supported NiAl₂O₄ spinel catalyst under conditions wherein the reactant gas mixture is at least partially steam reformed into a product gas mixture including H₂ and CO.

2. A process according to claim 1, wherein the reactant mixture is in gaseous state when contacted with the Al₂O₃-YSZ-supported NiAl₂O₄ spinel catalyst.

3. A process according to claim 1, wherein the hydrocarbonaceous fuel in liquid state at ambient temperature and atmospheric pressure.

4. A process according to claim 1, wherein the hydrocarbonaceous fuel is selected from the group comprising: at least one hydrocarbon, at least one oxygen-containing fuel, at least one biofuel, at least one fossil fuel, at least one synthetic fuel and a mixture thereof.

5. A process according to claim 1, wherein the hydrocarbonaceous fuel is selected from the group consisting of: gasoline, diesel, biodiesel, commercial fossil-derived diesel, synthetic diesel, jet fuel, methanol, ethanol, bioethanol, methane, alcohol, and mixture thereof.

6. A process according to claim 1, wherein the reactant mixture comprises H₂O in a liquid state and the hydrocarbonaceous fuel in a liquid state; said providing further comprises heating the reactant mixture to provide a gaseous reactant mixture; and said contacting comprises contacting the gaseous reactant mixture with the Al₂O₃-YSZ-supported NiAl₂O₄ spinel catalyst.

7. The process according to claim 1, further comprising at least one of atomizing and vaporizing the H₂O and the hydrocarbonaceous fuel to form an emulsion before contacting the Al₂O₃-YSZ-supported NiAl₂O₄ spinel catalyst.

8. The process according to claim 1, further comprising adding a surfactant to the H₂O and the hydrocarbonaceous fuel before atomizing or vaporizing the H₂O and the hydrocarbonaceous fuel to form the emulsion.

9. The process according to claim 1, wherein said contacting is carried out at a temperature between 500° C. and 900° C.

10. The process according to claim 1, wherein the hydrocarbonaceous fuel comprises carbon and the reactant mixture has a H₂O:carbon ratio between 2.3 and 3.

11. The process according to claim 1, wherein the contacting is carried out with a gas hourly space velocity ranging between 300 cm³g⁻¹h⁻¹ and 200 000 cm³g⁻¹h⁻¹.

12. The process according to claim 1, wherein the Al₂O₃-YSZ-supported NiAl₂O₄ spinel catalyst is substantially free of metallic nickel and nickel oxide.

13. The process according to claim 1, wherein the Al₂O₃-YSZ-supported NiAl₂O₄ spinel catalyst has a ratio Al₂O₃/YSZ ranging between 1/5 and 5/1.

14. The process according to claim 1, wherein the Al₂O₃-YSZ support consists essentially of Al₂O₃ and YSZ and comprises between 1 w/w % to 2 w/w % of yttria and the catalyst comprises an active phase consisting essentially of the NiAl₂O₄ spinel.

15. The process according to claim 1, wherein the Al₂O₃-YSZ-supported NiAl₂O₄ spinel catalyst comprises a molar ratio of Ni/Al₂O₃ smaller or equal to 1.

16. The process according to claim 1, wherein the Al₂O₃-YSZ-supported NiAl₂O₄ spinel catalyst comprises between 1 and 10 w/w % of nickel.

17. The process according to claim 1, wherein the Al₂O₃-YSZ-supported NiAl₂O₄ spinel catalyst is dispersed in quartz wool.

18. A synthesis gas for fuel cells obtained by the process of claim 1.

19. A The process according to claim 1 wherein the step of
providing a reactant mixture including a hydrocarbonaceous fuel and H₂O is carried out under steam reforming conditions.

20.-28. (canceled)

29. A catalyst for steam reforming of a hydrocarbonaceous fuel, the catalyst comprising:
a NiAl₂O₄ spinel-based catalytically active material; and
a support material comprising: Al₂O₃ and ZrO₂.

30. The catalyst of claim 29, wherein the ZrO₂ of the support material comprises yttria-stabilized zirconia (YSZ) and the catalyst comprises a Al₂O₃-YSZ-supported NiAl₂O₄.

31. The catalyst of claim 30, wherein Y₂O₃ is present in YSZ at about 1 w/w % to 2 w/w %.

32. The catalyst of claim 29, wherein the catalyst is substantially free of metallic nickel and nickel oxide.

33. The catalyst of claim 30, wherein the catalyst has a ratio Al₂O₃/YSZ ranging between 1/5 and 5/1.

34. The catalyst of claim 30, wherein the support material consists essentially of Al₂O₃ and YSZ and the catalytically active material consists essentially of the NiAl₂O₄ spinel.

35. The catalyst of claim 30, wherein the Al₂O₃-YSZ-supported NiAl₂O₄ catalyst comprises a molar ratio of Ni/Al₂O₃ smaller or equal to 1.

36. The catalyst of claim 30, wherein the catalyst comprises between 1 and 10 w/w % of nickel.

37. The catalyst of claim 30, wherein the Al₂O₃-YSZ-supported NiAl₂O₄ catalyst is dispersed in quartz wool.

38.-40. (canceled)

41. A method for the preparation of a Al₂O₃-YSZ-supported NiAl₂O₄ spinel catalyst, comprising the steps of:
mechanical mixing Al₂O₃ and yttria-stabilized zirconia (YSZ) powders to form a mixed powder;
wet impregnating of the mixed powders with an acquous nitrate solution to form an impregnated powder; and
submitting the impregnated powder under conditions to allow decomposition of nitrate and formation of NiAl₂O₄.

42.-51. (canceled)
